(19) United States
(12) Patent Application Publication
(10) Pub. No.: US 2026/0318869 A1
(43) Pub. Date: Oct. 15, 2026

(54) System and Method for Multi-Modal Threat Detection Using Integrated Sensing and Artificial Intelligence in Security Inspection

(71) Applicant: Hussam Adel Yousef Banawi, Jeddah (SA)

(72) Inventor: Hussam Adel Yousef Banawi, Jeddah (SA)

(21) Appl. No.: 19/173,856

(22) Filed: Apr. 9, 2025

(51) Int. Cl. G01N 27/622; G01N 21/31; G06V 10/82

(52) U.S. Cl. CPC G01N 27/622; G01N 21/3151; G06V 10/82

(57) ABSTRACT

A security inspection system for detecting prohibited materials integrates multiple sensing technologies. The system includes a conveyor configured to transport items through a security tunnel, an ion mobility spectrometry (IMS) module for chemical analysis, a multi-spectral imaging (MSI) module for capturing image data across multiple spectral bands, and a three-dimensional imaging module for spatial analysis. A processing unit receives data from the IMS, MSI, and three-dimensional imaging modules and analyzes the data using artificial intelligence models to identify potential threats and determine routing actions. A sorting module routes items based on the threat assessment, directing low-risk items along a primary path and diverting suspicious items for secondary inspection. The integrated system improves detection accuracy and reduces reliance on manual inspection, thereby streamlining security screening in transportation environments.

### FIELD OF INVENTION

The present invention relates generally to security inspection systems for detecting prohibited materials. More particularly, it pertains to systems that employ integrated sensing technologies and artificial intelligence for the automated screening of luggage and packages at transportation checkpoints, including airports, border crossings, and other secure facilities.

### BACKGROUND

Security screening at airports, border crossings, and other controlled access points is a key component of transportation infrastructure. Conventional screening systems, such as those employing X-ray imaging and basic sensors, are widely used to detect prohibited items and materials. However, these systems exhibit significant limitations in detection accuracy and throughput efficiency.

Existing X-ray-based inspection systems often produce false positives due to difficulty in distinguishing between benign and prohibited materials. As a result, manual secondary inspections are frequently required, increasing processing times and contributing to operational delays. These inefficiencies are particularly acute during peak travel periods, where limited screening capacity can negatively affect both passenger flow and security rigor.

In addition, conventional systems exhibit reduced sensitivity to non-metallic threats, such as plastic explosives or organic narcotics, which can be concealed in luggage in ways that evade standard imaging modalities. Incremental improvements to existing technologies have not adequately resolved these detection gaps.

While certain advanced technologies—such as trace detection portals, advanced imaging systems, and computed tomography (CT) scanners—have been introduced to supplement traditional screening tools, these systems are often deployed in isolation. The lack of integration between multiple detection modalities limits the ability to synthesize information across subsystems, and most current platforms continue to rely heavily on human operator interpretation, increasing the risk of inconsistency and error.

US Patent Publication No. US2023/252732 A1 discloses a system for real-time detection and visualization of chemical, biological, radiological, nuclear, and explosive (CBRNE) threats using multi-spectral imaging, ion mobility spectrometry (IMS), Raman spectroscopy, and augmented reality. While this system integrates various detection technologies for environmental threat monitoring, it does not address the specific requirements of high-throughput baggage screening in transportation environments. In particular, it lacks an integrated architecture optimized for automated luggage inspection, and does not incorporate artificial intelligence (AI)-driven fusion of IMS and imaging data to enable real-time threat detection and automated luggage handling.

Accordingly, there remains a need for improved security screening systems that integrate multiple sensing modalities—such as IMS and multi-spectral imaging (MSI)—in conjunction with AI-based data fusion to enhance detection performance, reduce false alarms, and improve operational efficiency within baggage inspection workflows.

It is within this context that the present invention is provided.

### SUMMARY

The present invention relates to a security inspection system that integrates multiple sensing technologies for detecting prohibited materials in items such as luggage. The system includes a conveyor system configured to transport items through a security tunnel, an ion mobility spectrometry (IMS) module for analyzing chemical compositions, a multi-spectral imaging (MSI) module for capturing image data across multiple spectral bands, and a three-dimensional imaging module for generating spatial data. A processing unit is communicatively coupled to these modules and is configured to receive and analyze data using artificial intelligence (AI) models to identify potential threats and determine corresponding routing actions. A sorting module is operably connected to the processing unit and routes the items based on the determined threat assessment. The integration of these components improves detection accuracy while reducing reliance on manual inspection, thereby enhancing both throughput and security screening efficiency.

The combined use of IMS for chemical analysis, MSI for material differentiation, and three-dimensional imaging for spatial analysis enables comprehensive detection of threat materials. By processing these diverse data streams using AI models, the system is capable of identifying a wide range of prohibited substances, including those that may evade detection by conventional systems that rely on a single sensing modality. The sorting module further streamlines screening operations by automatically directing items requiring additional scrutiny to secondary inspection, while allowing cleared items to proceed without delay.

In various embodiments, the IMS module comprises a drift tube operating at atmospheric pressure, an ionization source, a high-voltage gradient field generator, and a sampling system configured to collect air samples from items on the conveyor. This arrangement enables sensitive detection of trace volatile compounds, such as explosives, narcotics, and other prohibited substances, enhancing the system's capability to detect threats that may be concealed within luggage.

In some implementations, the IMS module further includes a dopant delivery system configured to enhance chemical selectivity for specific target compounds. This improves the specificity of detection and reduces false alarms by enabling the system to distinguish between benign and hazardous substances with similar chemical profiles.

In certain embodiments, the MSI module includes a plurality of imaging sensors, each configured to capture image data in a different spectral band, along with an illumination system configured to emit light across the multiple bands. This configuration allows the system to differentiate between materials based on their spectral signatures, which may be indistinct or visually identical under conventional visible-light imaging.

In further embodiments, the MSI sensors are configured to cover the visible spectrum, near-infrared (NIR), and short-wave infrared (SWIR) ranges. This broad spectral coverage increases the system's ability to detect and classify materials, including those engineered to avoid detection by standard imaging systems.

The three-dimensional imaging module may be implemented using one or more of the following technologies: structured light projection, time-of-flight ranging, or laser scanning. These modalities enable the generation of high-resolution volumetric data that can reveal concealed compartments, anomalous object shapes, or voids that may indicate the presence of hidden threats.

The processing unit may include neural networks trained to process input from each of the sensing modalities—IMS, MSI, and three-dimensional imaging—and a fusion algorithm configured to integrate the outputs of these networks. This architecture allows for accurate and comprehensive threat assessment by combining complementary information from distinct sensor domains.

In some embodiments, the AI models are updated based on results from secondary manual inspections, enabling the system to learn and adapt over time. This learning process improves detection performance and reduces false positive rates as the system encounters new threat types and operational contexts.

The sorting module may include a primary conveyor path for low-risk items, one or more diversion paths for items identified as suspicious, and a control mechanism configured to route items accordingly. This arrangement facilitates efficient screening by reducing human involvement in item classification.

In certain configurations, the sorting module includes an item tracking system for maintaining item identity throughout the screening process. The tracking system may utilize radio frequency identification (RFID) readers, barcode scanners, or computer vision-based tracking technologies to ensure that items remain properly associated with their corresponding threat assessments.

The system may be configured to cross-reference analytical results with a database of known prohibited materials. This comparison enhances threat identification accuracy and ensures the system remains current with evolving threat profiles.

In some embodiments, the system includes a display device coupled to the processing unit. The display is configured to present an augmented view of scanned items, visually indicating areas of concern based on the threat analysis. This functionality supports manual inspection by highlighting specific regions of interest.

The system may also assign confidence scores to threat assessments, and determine routing actions based on these scores. This probabilistic approach allows for nuanced classification of items and enables tailored responses according to the assessed risk level.

In certain implementations, the processing unit comprises a distributed computing architecture that includes one or more graphics processing units (GPUs) configured to accelerate execution of the AI models. This computing configuration supports real-time analysis of high-dimensional sensor data while maintaining acceptable throughput.

The system may include a communication interface configured to receive updates to the AI models and transmit performance metrics to a central security management system. This connectivity enables remote maintenance, centralized oversight, and coordinated system improvements across multiple installations.

Additionally, the system may detect spatial anomalies within items based on the three-dimensional imaging data and incorporate this information into the threat assessment. This allows the system to detect concealed compartments or voids, which are commonly used in smuggling attempts.

The routing logic may include directing items along a primary path for cleared items, diverting items to secondary inspection for manual review, or sending high-risk items to secure containment for further investigation. This tiered approach optimizes resource use and operational effectiveness.

In some embodiments, the MSI module is configured to capture image data across at least three distinct spectral ranges simultaneously. This enables comprehensive material analysis without extending scan durations.

Finally, the system may be implemented as a modular unit configured for integration into existing security checkpoint infrastructure. Such modularity enables deployment in various facilities without requiring substantial structural modifications.

### BRIEF DESCRIPTION OF THE DRAWINGS

Various embodiments of the invention are disclosed in the following detailed description and accompanying drawings.

FIG. 1 is a block diagram illustrating an example system architecture of a security inspection system, including the main components and their interconnections.

FIG. 2 is a process flow diagram depicting an example sequence of operations from item entry through data acquisition, analysis, and routing based on threat assessment.

FIG. 3 is a data integration diagram showing an example of how information from multiple sensing technologies is processed and combined to generate a unified threat assessment.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The terms “first,” “second,” and the like are used to distinguish different elements or features, but these elements or features should not be limited by these terms. A first element or feature described can be referred to as a second element or feature and vice versa without departing from the teachings of the present disclosure.

The term “security inspection system” refers to an apparatus configured to detect prohibited or hazardous materials within items being screened. Such systems may include, but are not limited to, those used at airports, border crossings, government buildings, and other secure facilities. In some embodiments, the security inspection system is positioned at an airport checkpoint where passenger luggage is screened prior to boarding and comprises a conveyor system integrated with one or more sensing modules and automated decision-making components.

The term “ion mobility spectrometry (IMS) module” refers to a component configured to analyze chemical substances by measuring the mobility of ionized molecules in an electric field through a carrier gas. The IMS module may include, but is not limited to, drift-tube IMS, traveling-wave IMS, or differential mobility spectrometry (DMS). In some embodiments, the IMS module utilizes a radioactive ionization source (e.g., Nickel-63), a temperature-controlled drift tube maintained at approximately 120 °C, and a dopant delivery system configured to introduce compounds such as ammonia or dichloromethane to improve selectivity for explosives including RDX, PETN, and TNT.

The term “multi-spectral imaging (MSI) module” refers to a component configured to capture image data across multiple spectral bands of the electromagnetic spectrum. These bands may include, but are not limited to, visible, near-infrared, short-wave infrared, and ultraviolet. In one example implementation, the MSI module includes four imaging sensors with spectral sensitivity ranges of approximately 400-700 nm (visible), 780-1100 nm (near-infrared), 1100-1700 nm (short-wave infrared), and 350-400 nm (ultraviolet), each having a resolution of at least 1280×1024 pixels.

The term “three-dimensional imaging module” refers to a component configured to generate spatial data representing the structure or geometry of an item. The module may include, but is not limited to, structured light projection systems, time-of-flight sensors, laser scanners, or computed tomography systems. In some embodiments, the module comprises a structured light system using a digital light processing (DLP) projector and a pattern sequence of 8 to 12 frames, coupled with grayscale cameras operating at 90 to 120 frames per second, to produce spatial resolution of approximately 2 mm at the conveyor height.

The term “artificial intelligence models” refers to computational algorithms configured to process input data and produce classifications, predictions, or threat assessments. These models may include, but are not limited to, neural networks, support vector machines, decision trees, and ensemble learning models. In one example, the models include a convolutional neural network using a ResNet-50 architecture for image classification, a one-dimensional convolutional network for IMS spectral data, and an attention-based fusion algorithm for combining outputs across sensing modalities.

The term “conveyor system” refers to a mechanical transport apparatus configured to move items through the inspection system. The conveyor may include, but is not limited to, belt conveyors, roller conveyors, or motorized transport platforms. In one embodiment, the conveyor comprises a continuous belt formed from carbon-filled polyurethane to minimize static buildup, driven by a variable-speed motor operating between 0.1 and 0.5 meters per second, and equipped with position encoders for synchronization with sensing modules.

The term “sorting module” refers to a subsystem configured to direct scanned items to various destinations based on a threat assessment. The sorting module may include, but is not limited to, diverter arms, powered roller assemblies, or split-belt mechanisms. In one example, the sorting module comprises pneumatically actuated diverter paddles with actuation times under 200 milliseconds, controlled via solenoid valves in communication with the processing unit, and equipped with feedback sensors to verify successful item diversion.

The term “processing unit” refers to a computational subsystem configured to receive data from sensing modules, execute analytical algorithms, and generate routing or threat assessment decisions. The processing unit may include, but is not limited to, one or more central processing units (CPUs), graphics processing units (GPUs), field-programmable gate arrays (FPGAs), or application-specific integrated circuits (ASICs). In some embodiments, the processing unit comprises an industrial-grade computer system including an Intel Xeon processor operating at 3.6 GHz, 32 GB RAM, an NVIDIA Tesla T4 GPU with 16 GB memory, and solid-state storage of at least 1 TB for software and data logging.

### Description of Drawings

The present invention provides a security inspection system configured to address limitations associated with conventional screening technologies used at transportation checkpoints such as airports, border crossings, and secure facilities. By integrating multiple sensing modalities—including ion mobility spectrometry (IMS), multi-spectral imaging (MSI), and three-dimensional imaging—with artificial intelligence-based data processing, the system facilitates improved threat detection and screening efficiency.

Conventional inspection systems, which typically rely on X-ray imaging and manual searches, often exhibit high false alarm rates, limited detection of concealed non-metallic threats, and a reliance on human interpretation that may introduce variability or fatigue-related errors. These limitations may result in delayed processing and operational inefficiencies.

The system disclosed herein implements a multi-layered detection approach that combines chemical analysis, material differentiation, and spatial mapping within a unified processing architecture. The integration of automated analysis and routing enables real-time threat assessment and decision-making.

In contrast to prior systems such as that disclosed in U.S. Patent Publication No. 2023/252732A1—which is directed to post-incident contamination mapping in environmental settings—the present system is designed for real-time, high-throughput screening of luggage and packages in transportation security applications. Although certain sensing technologies may be common to both, the present system provides an integrated workflow incorporating automated sorting mechanisms and artificial intelligence-driven fusion of sensor data, enabling responsive threat identification and item routing.

Among the technical benefits of the disclosed system are: (i) the use of complementary sensing modalities to detect a broad range of threat materials, including those that may evade single-modality detection; (ii) the application of artificial intelligence models to automate data analysis, reducing reliance on human operators; and (iii) the implementation of an automated sorting module that diverts only suspect items to secondary screening, improving overall screening throughput.

The following detailed description sets forth the system architecture, components, and method of operation. Various embodiments and implementation examples are provided for illustrative purposes and are not intended to limit the scope of the invention. It will be understood that modifications and alternatives consistent with the disclosed principles may be employed within the scope defined by the appended claims.

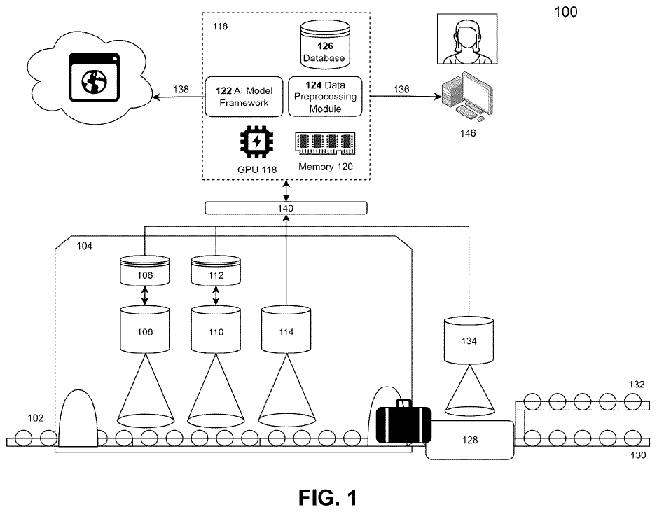

Referring now to FIG. 1, a block diagram of a security inspection system 100 is shown. The system 100 is configured to detect prohibited materials within items being screened and comprises a plurality of interconnected components arranged to process items sequentially while performing simultaneous multi-modal detection.

At the center of the system 100 is a conveyor system 102, which provides mechanical transport of items through the screening path. The conveyor system 102 is illustrated as a horizontal path, but may, in various implementations, include inclines, declines, or curved segments to accommodate site-specific spatial constraints. The conveyor system 102 may be constructed from anti-static materials, such as carbon-filled polyurethane, to reduce static charge accumulation that could interfere with detection subsystems or damage sensitive electronic items in transit.

Items transported on the conveyor system 102 pass through a security tunnel 104, which houses the primary sensing components. The tunnel 104 may include electromagnetic shielding to limit interference and, in certain embodiments, radiation shielding to comply with applicable regulations. The structure may be formed from steel, aluminum, or composite materials based on installation requirements, weight, and durability considerations.

Positioned adjacent to the conveyor system 102 within the tunnel 104 is an ion mobility spectrometry (IMS) module 106. The IMS module 106 is configured to analyze chemical compositions by measuring the mobility of ionized molecules in an electric field. The IMS module 106 may take the form of a unitary enclosure or, in some embodiments, may include multiple detection cells arranged to increase sampling area or provide redundancy. Suitable IMS technologies may include drift-tube IMS, traveling-wave IMS, or differential mobility spectrometry, selected based on sensitivity and detection requirements.

Associated with the IMS module 106 is an IMS sampling system 108, which collects air samples proximate to the items on the conveyor. The sampling system 108 may include one or more vacuum pumps operating at flow rates between approximately 0.5 and 2 liters per minute. In some configurations, heating elements may be included to promote volatilization of low vapor-pressure compounds, thereby enhancing chemical detection sensitivity.

A multi-spectral imaging (MSI) module 110 is also located within the tunnel 104. The MSI module 110 is configured to capture image data across multiple spectral bands to facilitate material differentiation based on spectral signatures. In certain embodiments, the MSI module 110 includes three to six distinct imaging sensors, each configured to operate within a different spectral range. These ranges may include visible (approximately 400-700 nm), near-infrared (approximately 780-2500 nm), and short-wave infrared (approximately 1000-3000 nm), and may optionally extend into ultraviolet or longer-wavelength infrared regions.

An MSI illumination system 112 is associated with the MSI module 110 and provides controlled lighting suitable for each spectral band of interest. The illumination system 112 may include LED arrays, halogen sources equipped with optical filters, or narrow-band light sources. In some implementations, the lighting may be pulsed or strobed in synchronization with sensor acquisition to enhance contrast or minimize power consumption.

Also disposed within the tunnel 104 is a three-dimensional imaging module 114 configured to generate spatial data representative of the external geometry of screened items. The imaging module 114 may utilize one or more structured light projection systems, time-of-flight sensors, or laser scanning assemblies. In some embodiments, multiple sensors may be arranged at different viewing angles to reduce occlusion and improve coverage for complex geometries.

Data from the IMS module 106, MSI module 110, and three-dimensional imaging module 114 are transmitted to a processing unit 116. The processing unit 116 may be implemented as a centralized or distributed computing system and is configured to perform real-time analysis of sensor inputs, threat determination, and routing control.

Within the processing unit 116 is GPU acceleration hardware 118, which may include graphics processing units (GPUs), tensor processing units (TPUs), or field-programmable gate arrays (FPGAs) configured to execute artificial intelligence models. In some embodiments, multiple accelerators may be used in parallel for load balancing or fault tolerance.

A memory storage system 120 is provided within the processing unit 116 to store operating software, sensor data, and processing results. The storage system 120 may include a combination of RAM, solid-state drives, and magnetic storage to accommodate varying requirements for speed, capacity, and data retention. In secure configurations, the memory storage system 120 may incorporate encryption, secure boot capabilities, and tamper protection.

An AI model framework 122 is implemented on the processing unit 116 to support execution of one or more artificial intelligence models. The framework 122 may support neural network architectures including convolutional neural networks, recurrent networks, or transformer-based models. The system may support live model updates without requiring downtime, enabling continuous adaptation and performance improvement.

A data preprocessing module 124 is also provided to perform normalization and transformation of raw sensor inputs. The preprocessing module 124 may implement filtering, alignment, format conversion, and feature extraction tailored to each sensor modality to prepare the data for AI-based classification.

A prohibited materials database 126 is communicatively coupled to the processing unit 116. The database 126 may store spectral, chemical, and spatial signatures associated with known prohibited materials, and may be regularly updated to reflect emerging threats and evolving detection criteria.

At the output of the conveyor system 102 is a sorting module 128 configured to direct items along different paths based on the computed threat assessment. The sorting module 128 receives control instructions from the processing unit 116 and may include diverter arms, split belt segments, or powered rollers to execute routing decisions in real time

A primary path 130 extends from the sorting module 128 and is configured to receive items determined to be low or no risk. The primary path 130 may lead to an exit area or collection point and may include indicators confirming clearance status.

A secondary inspection path 132 also extends from the sorting module 128 and receives items identified for additional scrutiny. This path may lead to manual inspection stations or auxiliary screening modules. The layout may be designed to segregate cleared and unverified items while maintaining efficient flow.

An item tracking system 134 is operably connected to the sorting module 128 and is configured to maintain item identity throughout the screening process. The tracking system 134 may utilize RFID readers, barcode scanners, or computer vision algorithms to continuously associate assessment results with specific items.

A user interface and display 136 is provided and coupled to the processing unit 116 to present system status, screening results, and visualizations of detected threats. The display 136 may include high-resolution monitors or augmented reality overlays, and in some implementations may support touch or gesture-based interaction.

The system 100 further includes a network interface 138 for communication with external systems, including centralized threat databases, security management platforms, or remote monitoring services. The network interface 138 may support wired or wireless protocols and incorporate encryption and authentication mechanisms for secure data exchange.

A control system 140 is coupled to the processing unit 116 and coordinates actuation of mechanical subsystems such as conveyor motion, diverter timing, and sensor synchronization. The control system 140 may include programmable logic controllers, industrial microcontrollers, or other automation components.

An operator workstation 146 is provided for manual control and interaction with the system. The workstation 146 may include an ergonomically designed console with controls and displays arranged for extended-use efficiency.

Finally, a feedback loop links secondary inspection results back to the processing unit 116. This loop enables the system to incorporate outcomes from manual inspection into model training or decision logic refinement. The feedback mechanism may include automated data capture as well as manual annotation by security personnel.

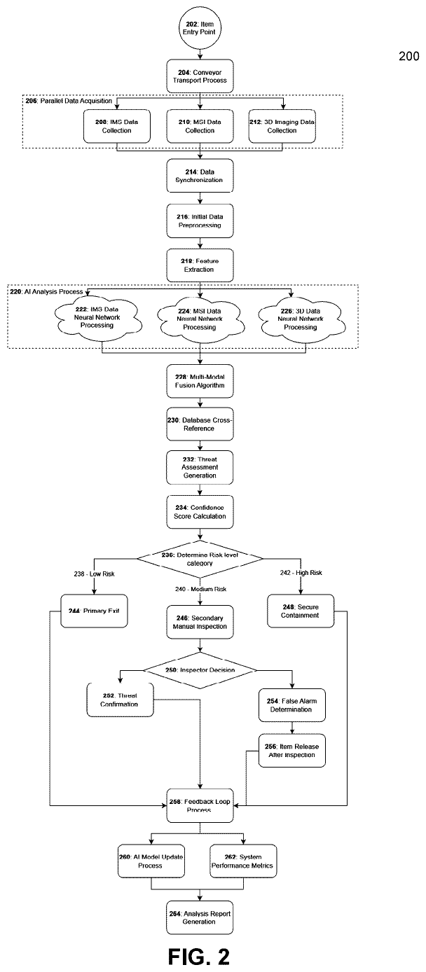

Referring now to FIG. 2, a process flow diagram 200 illustrates an operational sequence implemented by the security inspection system described above with respect to FIG. 1. The diagram 200 represents a comprehensive workflow from item entry to exit, including parallel data acquisition, artificial intelligence-based threat analysis, and multi-level routing based on assessed risk.

The process begins at an item entry point 202, where articles such as luggage, packages, or personal effects are introduced into the system. The entry point 202 may include one or more guide rails, alignment mechanisms, or item separation modules configured to ensure consistent positioning. In some implementations, the entry point 202 may include preliminary verification of size or weight to screen for items that exceed system handling capabilities.

Following entry, the item is transported via a conveyor transport process 204 through a scanning tunnel at a controlled velocity, typically between approximately 0.1 and 0.5 meters per second. The transport process 204 may include position encoding or motion feedback systems to synchronize data acquisition with item location, ensuring accurate registration of sensed features.

As the item progresses, it undergoes parallel data acquisition 206 from multiple sensing modalities simultaneously. These include chemical, spectral, and spatial sensors configured to operate concurrently. Synchronization may be achieved through hardware triggers or software-based time-stamping to ensure proper temporal and spatial correlation across all sensor streams.

Within the parallel acquisition stage, IMS data collection 208 samples air in proximity to the item, ionizes the sampled molecules, and measures their mobility in an electric field. The resulting IMS spectra represent relative ion mobility values corresponding to the presence of various chemical compounds. In some embodiments, environmental or system parameters may be adjusted dynamically to maintain target sensitivity levels.

Simultaneously, MSI data collection 210 captures image data across multiple predefined spectral bands. The MSI data collection 210 involves illumination of the item and collection of reflected or transmitted electromagnetic energy across wavelength ranges associated with known material properties. Frame synchronization and image alignment techniques may be employed to preserve inter-band correspondence.

Concurrently, 3D imaging data collection 212 generates volumetric or structural information about the scanned item. Depending on implementation, the system may employ structured light projection, stereo imaging, time-of-flight, or laser scanning to generate point clouds or voxel models. This data supports detection of suspicious geometries, concealed compartments, and other spatial anomalies.

After acquisition, a data synchronization process 214 aligns the chemical, spectral, and spatial datasets. This alignment may involve registration of sensor outputs to a common coordinate frame, temporal correlation across sensor clocks, and data format harmonization. This step ensures integrated analysis of sensor data with respect to precise item location.

Once synchronized, the data undergoes initial data preprocessing 216 to enhance signal fidelity and reduce noise. Preprocessing techniques may include background subtraction, normalization, filtering, and contrast adjustment, adapted to the characteristics of each sensing modality.

Following preprocessing, a feature extraction process 218 identifies data structures or attributes associated with potential threats. The feature extraction process 218 may involve chemical fingerprinting, spectral anomaly detection, material classification, void detection, and geometric analysis. These extracted features serve as compact and informative representations for downstream inference processes.

The extracted features are passed to an AI analysis process 220, which applies artificial intelligence models to evaluate threat likelihood. The analysis process 220 may include multiple neural networks, each trained for a specific modality, and optimized for different aspects of detection.

Within this stage, IMS data neural network processing 222 analyzes ion mobility spectra to identify chemical compounds of interest. Neural networks employed here may include one-dimensional convolutional or recurrent architectures, trained on known threat compounds and capable of detecting anomalous chemical profiles.

In parallel, MSI data neural network processing 224 analyzes the spectral imaging data to identify material signatures. The processing may utilize two-dimensional convolutional networks with multi-channel inputs corresponding to the spectral bands. These networks are trained to distinguish prohibited substances from visually similar but benign materials.

Additionally, 3D data neural network processing 226 evaluates spatial information for suspicious structural features. This analysis may use 3D convolutional networks, graph-based models, or spatial encoding methods capable of operating on point cloud or volumetric input. Such networks may be trained to detect features indicative of hidden compartments, abnormal densities, or packaging inconsistencies.

Outputs from the modality-specific networks are aggregated by a multi-modal fusion algorithm 228 configured to combine evidence and resolve discrepancies. The fusion algorithm 228 may apply attention-based weighting, Bayesian integration, or ensemble learning techniques to produce a unified assessment with an associated confidence level.

Subsequently, a database cross-reference 230 compares detection results to reference profiles stored in the system's prohibited materials database. This step may validate candidate detections, associate findings with known threat categories, or exclude materials with benign characteristics.

A threat assessment generation 232 follows, producing a detailed evaluation of the scanned item, including identification of suspected threats, location data, classification (e.g., explosive, narcotic, weapon), and severity level. This output informs downstream sorting and handling processes.

A confidence score calculation 234 accompanies the threat assessment, quantifying system certainty based on sensor clarity, cross-modal consistency, and historical model accuracy. The confidence score informs routing decisions and assists human operators in triage and prioritization.

At a decision point 236, the item is routed along one of several inspection paths based on the generated assessment and confidence score. Decision logic may include tunable thresholds and rulesets, which may be dynamically updated based on operational context or threat level advisories.

Items assessed as low risk are directed along a low risk path 238, proceeding without further inspection. This path maintains continuous item flow while enabling item separation as needed.

Items associated with intermediate threat indicators follow a medium risk path 240, leading to a secondary screening area where targeted manual inspection is performed based on system guidance.

Items classified as high risk follow a high risk path 242, which may include containment procedures, isolation handling, and escalation to specialized inspection protocols. The high risk path 242 may involve automated or manual intervention based on facility configuration.

Cleared items on the low risk path proceed to a primary exit 244, where they are returned to the owner or advanced to subsequent transport stages. This area may include indicators or display panels confirming item clearance.

Items on the medium risk path are subject to secondary manual inspection 246 by trained personnel. The manual inspection may be guided by system-generated visualizations and include additional tools such as swab-based trace detectors or handheld imaging devices.

Items determined to present significant risk may be routed to secure containment 248 for specialized handling. Secure containment facilities may include controlled environments, access restrictions, and specialized safety equipment for handling potentially hazardous materials.

A human operator makes an inspector decision 250, confirming whether the system's alert represents a true threat or a false alarm. This decision step is used both for immediate response and for system learning and performance tracking.

If a threat is confirmed, a threat confirmation 252 record is created, documenting the item's identity, the material detected, and associated metadata. This record may trigger further security actions.

If no threat is confirmed, a false alarm determination 254 is recorded. This data may include suspected causes of the false positive and inform subsequent model updates or algorithm tuning.

Once cleared, the item undergoes item release after inspection 256, returning it to general processing. Documentation of inspection results may be applied to the item, and return procedures may include tracking and owner verification.

Inspection outcomes are incorporated into a feedback loop process 258, which supports performance analysis and machine learning-based model refinement. Both confirmed threats and false alarms may be annotated and recorded.

This data is then used in an AI model update process 260, where neural networks and other detection algorithms are retrained, adapted, or updated. Learning strategies may include incremental updates, periodic retraining, or reinforcement learning protocols.

Throughout operation, the system maintains system performance metrics 262, tracking operational throughput, false positive rates, detection confidence, and response time. These metrics may be displayed in real-time and reviewed periodically for system validation and calibration.

Finally, an analysis report generation 264 stage compiles summaries of operational data, threat detections, false alarms, and system status. Reports may be generated on a scheduled or event-driven basis to support compliance, oversight, and continuous improvement.

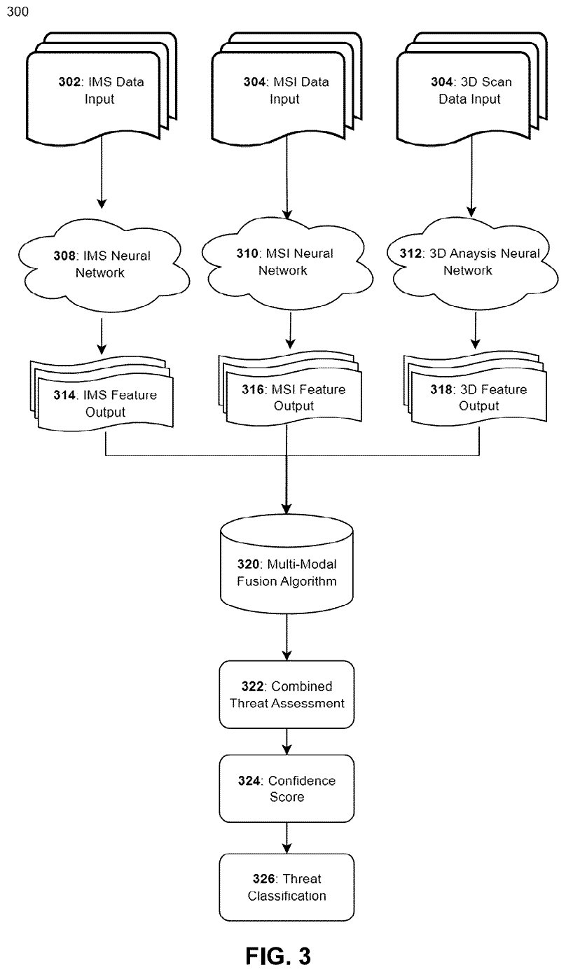

Referring now to FIG. 3, a multi-modal data integration diagram 300 is illustrated. The diagram 300 depicts how data from multiple sensing modalities is processed and combined to generate a comprehensive threat assessment. The data integration framework includes sensor-specific neural network processing pipelines and a fusion architecture that consolidates intermediate outputs to produce a unified evaluation.

At the upper portion of the diagram are three primary data inputs corresponding to the main sensing modalities of the security inspection system. An IMS data input 302 represents ion mobility spectrometry output in the form of a spectral graph containing peaks that correspond to detected chemical compounds. This spectrum typically includes drift time on the horizontal axis and signal intensity on the vertical axis. The peak patterns serve as chemical fingerprints and enable compound identification. In some embodiments, multiple IMS spectra may be collected from different sampling zones or using varied ionization conditions to expand detection coverage.

Adjacent to the IMS data is an MSI data input 304, comprising a sequence of image frames across multiple spectral bands. The MSI data input 304 captures a consistent field of view at differing wavelengths, revealing material characteristics that may not be discernible under conventional visible-light imaging. Typical spectral bands include visible (400-700 nm), near-infrared (780-2500 nm), and short-wave infrared (1000-3000 nm), though additional bands such as ultraviolet or long-wave infrared may be included as needed. The MSI data may be rendered as false-color composites to visually emphasize material distinctions based on reflectance, absorption, or fluorescence properties.

The third input, a 3D scan data input 306, represents the spatial structure of the scanned item, typically as a point cloud or wireframe model. The 3D scan data 306 captures physical geometry, internal features, and potential density anomalies. Acquisition methods may include structured light, time-of-flight, or laser scanning technologies. In some implementations, density information derived from X-ray attenuation may be integrated into the 3D data to enrich structural context.

Each of the three data inputs is processed by a respective neural network tailored to its modality. The IMS neural network 308 processes spectral data to identify chemical substances. This network may employ one-dimensional convolutional or recurrent architectures adapted for temporal spectral signals and trained using libraries of chemical signatures, including explosives, narcotics, and other contraband. The network may include attention mechanisms configured to focus on discriminative spectral regions while minimizing false positive influence from benign compounds.

In parallel, the MSI neural network 310 analyzes the multi-spectral image data to identify material properties based on spectral signatures. The MSI neural network 310 may utilize convolutional architectures with multi-channel input layers aligned to different spectral bands. These networks are trained to distinguish visually similar materials with differing chemical compositions, and may include spatial attention layers to localize regions of interest within the scanned item.

Simultaneously, a 3D analysis neural network 312 processes the spatial data to identify irregularities or suspicious structures. This network may employ 3D convolutional networks, graph neural networks, or other architectures suited to point cloud or volumetric input. These models are trained to detect geometric anomalies, voids, or shapes consistent with known threat objects, and may incorporate geometric deep learning techniques that leverage structural relationships inherent to the data.

Each of the modality-specific networks generates an intermediate feature output that is passed to a fusion algorithm. The IMS feature output 314 includes detected chemical species, their estimated concentrations, and associated confidence scores. It may contain both recognized threat compound identifications and anomaly indicators for unknown or uncharacterized substances.

The MSI feature output 316 comprises material classifications and associated spatial maps, highlighting areas with spectral characteristics matching profiles of known threats. Confidence levels for each classification are included to support downstream weighting and decision-making.

The 3D feature output 318 includes detected structural anomalies such as voids, high-density inclusions, or objects with suspicious shapes. This output may include spatial coordinates, volume estimates, classification probabilities, and geometric descriptors corresponding to recognized or suspect items.

These three intermediate outputs are input to a multi-modal fusion algorithm 320 configured to generate an integrated threat evaluation. The fusion algorithm 320 may employ methods such as attention-weighted scoring, Bayesian inference, ensemble voting, or rule-based integration. The algorithm is structured to exploit cross-modality correlations—for example, reinforcing a spectral detection with spatial anomaly confirmation—and to resolve conflicting signals based on context or prior performance metrics.

The output of the fusion algorithm is a combined threat assessment 322, which synthesizes the independent analyses into a unified decision. The assessment includes several key components:
A confidence score 324 that quantifies the overall certainty of the detection result, represented as a numerical probability or classification strength. The confidence score 324 reflects the consistency and strength of evidence across all sensor modalities and is used to inform routing decisions and manual inspection priorities.
A threat classification 326 that designates the type of detected material or object, such as explosives, narcotics, weapons, or chemical agents. Classifications may include primary and secondary threat categories in cases of overlapping detections or composite objects.
A threat location data 328 element that specifies the spatial coordinates within the scanned item where a threat has been identified. This positional data enables targeted inspection during secondary screening and reduces the need for full item disassembly or generalized search.

The multi-modal data integration strategy shown in FIG. 3 provides a significant enhancement over single-modality detection systems. By combining complementary sensing technologies—chemical analysis via IMS, material classification via MSI, and structural inspection via 3D imaging—the system increases detection coverage and reliability. Integration of these modalities enables cross-validation of detection cues and reduces the likelihood of both false negatives and false positives, thereby improving overall system performance and operational efficiency in high-throughput security environments.

### Controller/Processor Components

A processor or controller as described herein may include any suitable type of computing device, such as a central processing unit (CPU), microcontroller, graphics processing unit (GPU), system on a chip (SoC), or digital signal processor (DSP). It may operate with one or more cores and may be configured to execute the functions described in this disclosure.

The processor may be operably connected to one or more memory devices, such as random access memory (RAM), read-only memory (ROM), flash storage, or solid-state drives (SSD). These memory devices store computer-readable instructions that, when executed by the processor, perform the methods described. The processor and memory communicate via data buses or other suitable communication pathways.

The computing device may also include input/output (I/O) devices, such as a touchscreen, mouse, keyboard, display, or speaker, to facilitate interaction with users or other systems. Additionally, it may include a network interface, such as a wired or wireless communication module, for connecting to networks.

Control logic or software instructions may be stored in memory and executed by the processor to implement specific functionalities. This logic may be modular, consisting of software components, processes, or functions that work together to perform the operations described herein.

The described computing operations involve the manipulation of data represented as electrical, optical, or magnetic signals stored or transferred within the system. These operations are machine-executed and do not require manual intervention, though they may interface with human operators through appropriate user interfaces.

The systems and methods described are not limited to any particular hardware configuration or programming language and may be implemented on general-purpose or specialized computing devices.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the security inspection system of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A security inspection system, comprising:
(a) a conveyor system configured to transport items along a conveyance path through a security tunnel;
(b) an ion mobility spectrometry (IMS) module positioned adjacent to the conveyor system and configured to analyze chemical compositions of the items;
(c) a multi-spectral imaging (MSI) module positioned adjacent to the conveyor system and configured to capture image data of the items across multiple spectral bands;
(d) a three-dimensional imaging module positioned adjacent to the conveyor system and configured to generate spatial data corresponding to the items;
(e) a processing unit operably coupled to the IMS module, the MSI module, and the three-dimensional imaging module, the processing unit comprising:
(i) a memory storing instructions; and
(ii) one or more processors configured to execute the instructions to:
(1) receive chemical composition data from the IMS module, spectral image data from the MSI module, and spatial data from the three-dimensional imaging module;
(2) analyze the data using one or more artificial intelligence models to identify potential threat materials associated with the items;
(3) generate a threat assessment based on the analysis; and
(4) determine a routing action for each of the items based on the threat assessment; and
(f) a sorting module operably coupled to the processing unit and configured to route the items in accordance with the determined routing action.

2. The security inspection system of claim 1, wherein the IMS module comprises:
(a) a drift tube configured to operate at atmospheric pressure;
(b) an ionization source;
(c) a high-voltage gradient field generator; and
(d) a sampling system configured to collect air samples from items on the conveyor system.

3. The security inspection system of claim 2, wherein the IMS module further comprises a dopant delivery system configured to enhance selectivity for one or more target compounds.

4. The security inspection system of claim 1, wherein the MSI module comprises:
(a) a plurality of imaging sensors, each configured to capture image data in a respective spectral band; and
(b) an illumination system configured to provide lighting across the spectral bands.

5. The security inspection system of claim 4, wherein the plurality of imaging sensors includes at least one sensor for each of: a visible spectrum band, a near-infrared band, and a short-wave infrared band.

6. The security inspection system of claim 1, wherein the three-dimensional imaging module comprises at least one of:
(a) a structured light projection system;
(b) a time-of-flight system; or
(c) a laser scanning system.

7. The security inspection system of claim 1, wherein the artificial intelligence models comprise:
(a) a first neural network configured to process data from the IMS module;
(b) a second neural network configured to process data from the MSI module;
(c) a third neural network configured to process data from the three-dimensional imaging module; and
(d) a fusion algorithm configured to combine outputs of the neural networks.

8. The security inspection system of claim 7, wherein the one or more processors are further configured to update one or more of the artificial intelligence models based on feedback received from secondary inspections.

9. The security inspection system of claim 1, wherein the sorting module comprises:
(a) a primary conveyor path for items determined to be low-risk;
(b) at least one diversion path for items determined to require secondary screening; and
(c) a control mechanism configured to divert items from the primary conveyor path to the at least one diversion path.

10. The security inspection system of claim 9, wherein the sorting module further comprises an item tracking system configured to maintain item identification throughout the security inspection system.

11. The security inspection system of claim 10, wherein the item tracking system comprises at least one of:
(a) a radio frequency identification (RFID) reader;
(b) a barcode scanner; or
(c) a computer vision-based tracking system.

12. The security inspection system of claim 1, wherein the one or more processors are further configured to:
(a) cross-reference analysis results with a database of prohibited materials; and
(b) update the threat assessment based on the cross-referencing.

13. The security inspection system of claim 1, further comprising a display device operably coupled to the processing unit and configured to present an augmented view of the items, wherein the augmented view highlights locations of potential threat materials.

14. The security inspection system of claim 1, wherein the one or more processors are further configured to:
(a) assign a confidence score to the threat assessment; and
(b) determine the routing action based on the confidence score.

15. The security inspection system of claim 1, wherein the processing unit comprises a distributed computing architecture including at least one graphics processing unit (GPU) configured to accelerate execution of the artificial intelligence models.

16. The security inspection system of claim 1, further comprising a communication interface configured to:
(a) receive updates to the artificial intelligence models; and
(b) transmit system performance data to a central security management system.

17. The security inspection system of claim 1, wherein the one or more processors are further configured to:
(a) detect spatial anomalies within the items based on data from the three-dimensional imaging module; and
(b) update the threat assessment based on the detected spatial anomalies.

18. The security inspection system of claim 1, wherein the routing action comprises one of:
(a) directing the item along a primary path for cleared items;
(b) directing the item to a secondary inspection area for manual inspection; or
(c) directing the item to a secure containment area for high-risk items.

19. The security inspection system of claim 1, wherein the MSI module is configured to synchronously capture image data across at least three distinct spectral ranges.

20. The security inspection system of claim 1, wherein the security inspection system is configured as a modular unit adapted for installation within existing security checkpoint infrastructure without requiring structural modification.
